(19) United States
(12) Patent Application Publication
(10) Pub. No.: US 2004/0129312 A1
(43) Pub. Date: Jul. 8, 2004

(54) Water system tampering sensing device

(76) Inventors: Joseph Cuzzo, Carteret, NJ (US); William Spilfogel, Wellington, FL (US); Jeffrey A. Spilfogel, Wellington, FL (US); Donald C. Johnson, Wellington, FL (US)

Correspondence Address: Mr. Walter J. Tencza Jr., Suite 3, 10 Station Place, Metuchen, NJ, 08840, US

(21) Appl. No.: 10/336,436

(22) Filed: Jan. 3, 2003

(51) Int. Cl. F16K 35/10

(52) U.S. Cl. 137/296

(57) ABSTRACT

A transmitter and a water system or distribution protection device, such as a fire hydrant protection device, is disclosed. The water system protection device inhibits an unauthorized individual from accessing water from a water system device, such as a fire hydrant. The transmitter transmits a first signal when the water system protection device is tampered with. One or more sensing devices are provided that sense when the water system protection device has been tampered with, and cause the transmitter to transmit the first signal. The transmitter may also transmit a normal operation signal indicating that the water system protection device has not been tampered with. The first signal may be encrypted. The first signal may indicate the location of the water system device. An alarm, located at or near the water system device, may be activated when the water system protection device is tampered with.

### FIELD OF THE INVENTION

This invention relates to improved methods and apparatus concerning protecting water system devices, such as fire hydrants, from terrorism, vandalism, or interference with the water supply from those water system devices.

### BACKGROUND OF THE INVENTION

Typically in the prior art, water system devices, such as fire hydrants have been relatively easy to tamper with, and any tampering would be undetected until much damage had been done. This has become a more serious issue due to the concern regarding possible terrorist contamination of municipal water supplies. Thus far, the approach to protecting municipal water systems has been to heighten security at central sites such as reservoirs, treatment plants and pumping stations. However, these measures do nothing to address the problem of drinking water contamination by terrorists attacking a city's water supply via the network of easily accessible fire hydrants and/or down-line distribution outlets.

The general public is unaware that fire hydrants are connected to the municipal drinking water system. A hydrant, capable of passing hundreds of gallons per minute, provides an easy and effective means of injecting large volumes of chemical contaminants. And, since hydrants are located in the communities they serve—downline of reservoirs, treatment plants, and pumping stations—such acts of terrorism would evade any treatment, monitoring and other protective measures currently in place.

If a municipal reservoir were to be attacked by chemicals, even in large amounts such as a tanker load, the dilution effect would quickly reduce their concentrations. If, on the other hand, the same amount of chemical was dispensed into a municipal fire hydrant, there would be a dangerous consequence. The entire load of chemicals would be quickly distributed in high concentrations throughout the city's network of water mains. The effects would be both immediate and devastating.

Unfortunately, the design of the municipal fire hydrant provides virtually no security from attack. Clearly, hydrant tampering, once simply an act of teenage vandalism now has the potential to become a serious threat to our nation's water systems, deserving of careful consideration.

### SUMMARY OF THE INVENTION

The present invention in one or more embodiments provides a monitoring, sensing and notification device as a part of a water distribution or water system protection device, such as a fire hydrant protection device. A fire hydrant may be considered to be a type of water system device or water distribution device in this application. The monitoring or sensing device senses when tampering of the water system protection device has occurred and generates a signal to a remote monitoring facility. The signal may be an encrypted location identification signal, which provides data specifying the location of the water system protection device that has been tampered with. A violation of a water system protection device's integrity is detected and the appropriate law enforcement authorities, such as police, can be notified at the onset of a tampering event. The monitoring or sensing device may not be limited to only fire hydrants, but may be provided at various points along a water distribution network on a water system device. The monitoring or sensing device generally should not be accessible unless properly removed by an authorized person, or unless tampered with.

In at least one embodiment of the present invention an apparatus is provided comprising a transmitter, which may be a telemetry transmitter, and a water system protection device, which may be a fire hydrant protection device. The water system protection device inhibits an unauthorized individual from accessing water in a water system. For example the water system protection device may inhibit an individual from accessing water through a fire hydrant. The water system protection device may be a fire hydrant protection device such as the devices disclosed in U.S. Pat. No. 6,463,953, which is incorporated by reference herein. The transmitter transmits a first signal, when the water system protection device, such as a fire hydrant protection device, is tampered with. The apparatus may also include one or more sensing devices that sense when the water system protection device has been tampered with, and cause the transmitter to transmit the first signal. The transmitter may also transmit a normal operation signal indicating that the water system protection device has not been tampered with. The first signal may be encrypted. The first signal may indicate the location of the water system protection device. An alarm may be located at or near the water system protection device.. The alarm may be activated when the water system protection device is tampered with. The alarm may be activated and the signal may be transmitted simultaneously upon a tampering event.

### BRIEF DESCRIPTION OF THE DRAWINGS

FIG. 1A shows a top view of a water system protection device in accordance with an embodiment of the present invention with this particular water system protection device shown in a closed state;

FIG. 1B shows a top view of the water system protection device of FIG. 1A with this particular water system protection device shown in an open state;

FIG. 1C shows a top view of the water system protection device of FIG. 1C in the closed state placed on a fire hydrant;

FIG. 1D shows a front view of the fire hydrant along with an outline of the location of the water system protection device of FIG. 1A when it is placed on the fire hydrant and thereafter put in the closed state;

FIG. 1E shows a front view of the fire hydrant with the water system protection device of FIG. 1A locked thereon in the closed state;

FIG. 2 shows a flow chart of a method for detecting and punishing tampering of a water system protection device, such as the device of FIGS. 1A-D;

FIG. 3 shows a block diagram of components of a water system protection device; and

FIG. 4 shows a block diagram of components of a remote monitoring facility.

### DETAILED DESCRIPTION OF THE DRAWINGS

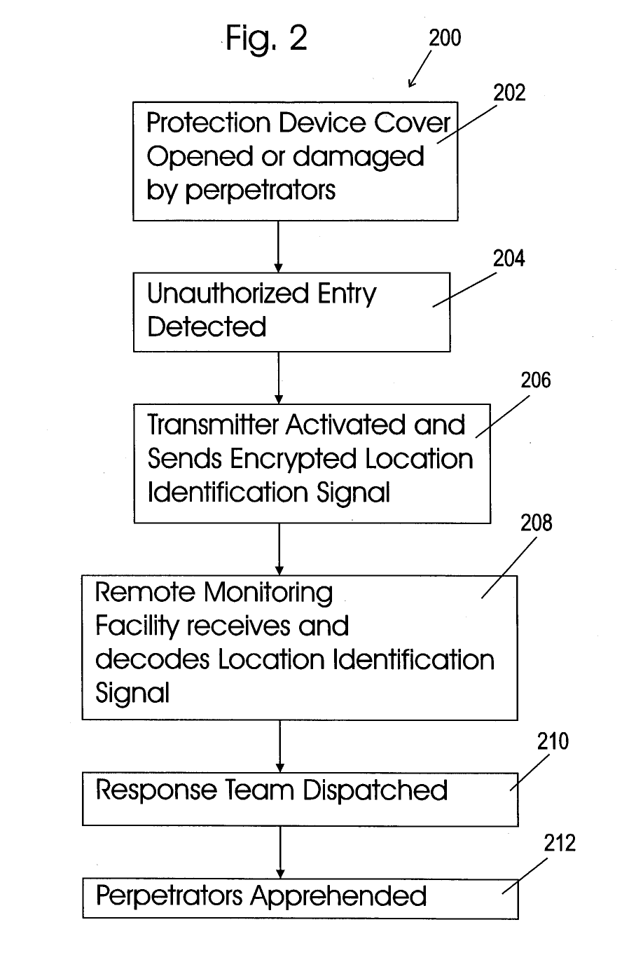

The present invention incorporates by reference U.S. Pat. No. 6,463,953, titled “FIRE HYDRANT PROTECTIVE DEVICE”, issued on Oct. 15, 2002. The tamper protection devices and methods of the present application can be used in conjunction with any water system or water distribution protection device including any of the fire hydrant protection devices shown in U.S. Pat. No. 6,463,953, including the fire hydrant protection devices shown in FIGS. 2, 3, 5, 6A-6E, and 7A-7D of U.S. Pat. No. 6,463,953. The tamper protection devices and method of the present application can be used with other water system protection devices, such as devices designed to protect pipes, reservoirs, and water treatment facilities.

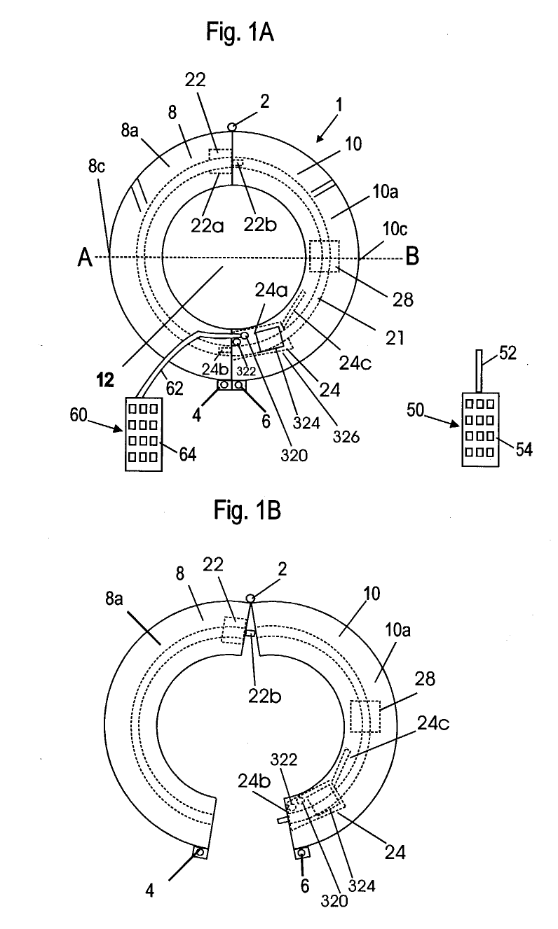

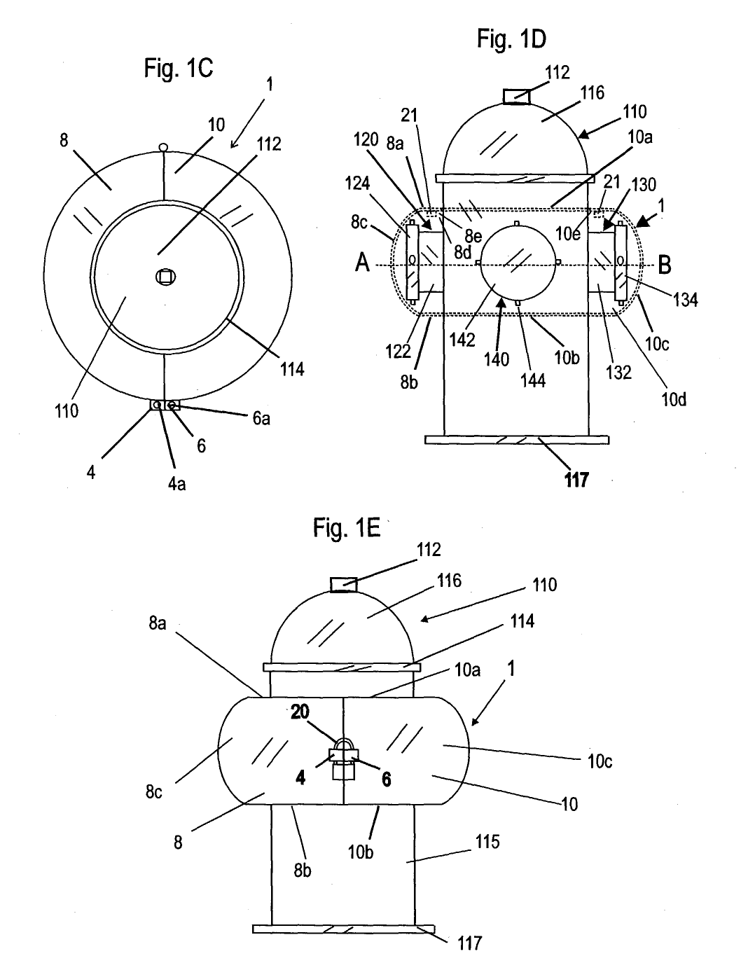

FIG. 1A shows a top view of a water system protection device 1 in accordance with an embodiment of the present invention in a closed state. In this case the water system protection device 1 is a fire hydrant protection device. FIG. 1B shows a top view of the protection device 1 in an open state. FIG. 1C shows a top view of the protection device 1 in the closed state placed on a fire hydrant 110. FIG. 1D shows a front view of the fire hydrant 110 along with an outline of the location of the protection device 1 of FIG. 1A when the protection device 1 is placed on the fire hydrant 110 and thereafter put in the closed state. FIG. 1E shows a front view of the fire hydrant 110 with the protection device 1 of FIG. 1A locked thereon in the closed state. The fire hydrant 110 includes a top portion 112, a bonnet 116, a top peripheral portion 114, a body portion 115, and a bottom peripheral portion 117. The body portion 115 may be comprised of a solid metal cylinder. The fire hydrant 110 may also include nozzle devices, such as nozzle devices 120, 130, and 140. The fire hydrant 110 may be similar to the fire hydrant 10 shown in U.S. Pat. No. 6,463,953 incorporated by reference herein. Nozzle device 120 is comprised of a nozzle cap 124. The nozzle cap 124 covers the nozzle tube 122 and prevents water from coming out of the fire hydrant 110 through the nozzle tube 122.

Similarly, nozzle device 130 is comprised of nozzle cap 134. In addition, nozzle device 130 includes nozzle tube 132. The nozzle cap 134 covers the nozzle tube 132 and prevents water from coming out of the fire hydrant 110 through the nozzle tube 132. Similarly, nozzle device 140 is comprised of nozzle cap 144 and nozzle tube 142.

The water system protection device 1 includes a hinge 2, hasps 4 and 6, and portions 8 and 10. The portions 8 and 10 come together in the closed state of FIG. 1A to form a donut shape, having a central opening 12 as shown in FIG. 1E. Portions 8 and 10 have top surfaces 8a and 10a, bottom surfaces 8b and 10b, and curved side surfaces 8c and 10c, respectively. As shown in FIG. 1D, a channel 8d is within the borders of the top surface 8a, the bottom surface 8b, and the curved surface 8c and similarly a channel 10d is within the borders of the top surface 10a, the bottom surface 10b, and the curved surface 10c. The nozzle devices, such as nozzle devices 120, 130, and 140, shown in FIG. 1D of the fire hydrant 110 can be inserted into one or both of channels 8d or 10d. The top surfaces 8a and 10a, bottom surfaces 8b and 10b, and curved surfaces 8c and 10c prevent the nozzle devices, such as nozzle devices 120, 130, and 140 from being accessed in the closed state as shown by FIGS. 1D and 1E. The portions 8 and 10 separately or together may be termed a cover. The hinge 2, hasps 4 and 6, and lock 20 may be termed part of an attachment device for attaching a cover comprised of one or both of portions 8 and 10 to the fire hydrant 110. One or both of the portions 8 and 10 may also be thought of as being part of an attachment device for attaching a cover comprised of one or both of portions 8 and 10 to the fire hydrant 110.

The outline shown in FIG. 1D of the water system protection device 1 is obtained by cutting the device 1 in half as shown in FIG. 6A along the line AB and looking inside one half of the device 1. The water system protection device 1 may be placed in an open state as in FIG. 1B and then closed as shown by FIGS. 1C, 1D, and 1E around the fire hydrant 110 so that all nozzle devices such as nozzle devices 120, 130, and 140 are protected with one or both of the channels 8d and 10d. After the water system protection device 1 has been closed as in FIG. 1C, a locking device 20, such as a key or combination lock, ring, wire, seal, or the like may be inserted in holes 4a and 6a to connect the hasp 4 with the hasp 6 and to thereby lock the device 1 to the hydrant 110. The protection device 1 may also be thought of as including the locking device 20 shown in FIG. 1E for locking the device 1 onto the fire hydrant 110.

In at least one embodiment, the water system protection device 1 is protected by one or more antitampering devices, such as break detection wires 21, a tamper detection switch 22, a combination tamper switch and transmitter 24, and further anti-tampering devices 28. Anti-tampering devices, such as 21, 22, 24, and 28 may be considered to be add-ons to the water system protection device 1, or a part of the water system protection device 1. The devices 21, 22, 24, and 28, are shown in dashed lines, and should be provided within the water system protection device 1, so that they are inaccessible to an unauthorized person unless the device 1 is tampered with. The break detection wires 21 may be located just inside the portions 8 and 10, such as on or imbedded within the interior surfaces 8e and 10e as shown in FIG. 1D. The tamper detection switch 22 may be comprised of portions 22a and portion 22b. The combination tamper switch and transmitter 24 may be comprised of portions 24a, 24b, and 24c. Portion 24c is a transmitter. In at least one embodiment, the opening, damage or destruction of the water system protection device 1 by perpetrators such as unauthorized personnel or vandals results in the change of the state of the water system protection device 1 from closed in FIG. 1A to open in FIG. 1B, may cause the portion 22b to separate from the portion 10 of the water system protection device 1, may cause the portion 24b to separate from the portion 8 of the fire hydrant protection device 1, may cause the break detection wire 21 to split in half, and may cause the activation of additional sensing devices 28 which may be a vibration sensor, temperature sensor or other tamper sensors. Any one of these conditions may cause a signal to be sent to a monitoring station by transmitter 24c to indicate that the water system protection device 1 has been tampered with.

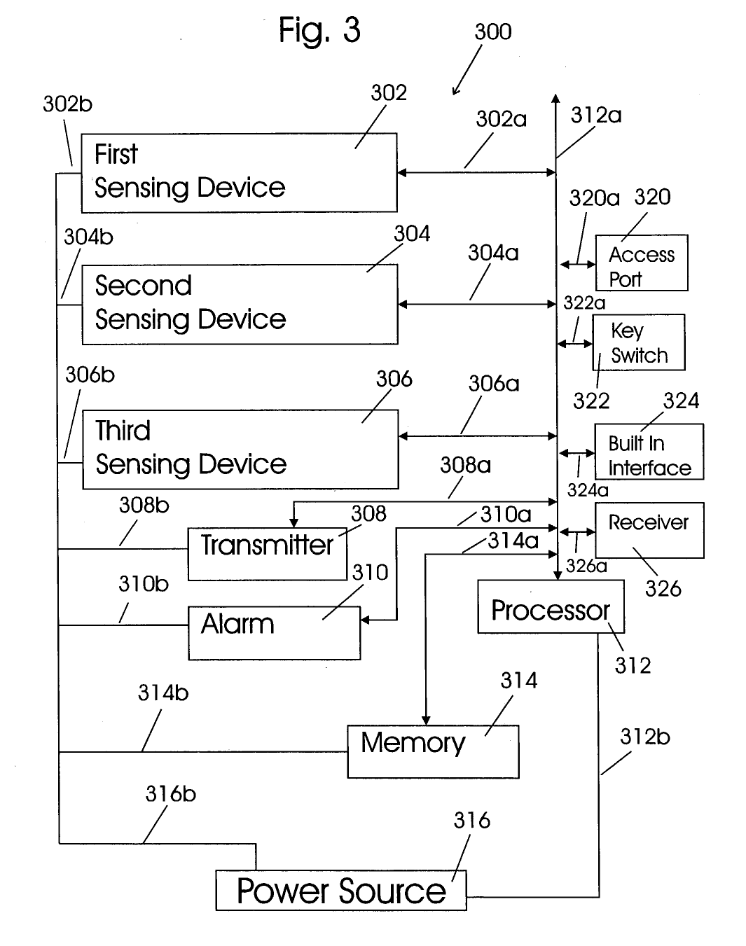

In another embodiment of the invention, the signal transmission function of the water system protection device, such as device 1, may be field-deactivated by authorized persons (fire, law enforcement, utility departments, etc.) for legitimate purposes. The device 24 may include a built in interface 324, an access port 320, and a key switch 322. The interface 324, access port 320, and key switch 322 may be accessible from the outside of the protection device 1. If an individual has a proper key, wired or wireless interface and/or code to deactivate the anti-tampering features of the water system protection device 1 (such as the anti-tampering features of apparatus 300 of FIG. 3 which may be incorporated therein), the key switch 322 or either disabling device may deactivate some or all of these tamper detection devices. The interface 324 may include a keypad which may also allow anti-tampering devices to be deactivated by authorized personnel. Detachable interface 60 may be part of the water system protection device 1 or may be connected to the water system protection device 1 through a wire 62 which may be connected to access port 320. The detachable interface 60 may have a keyboard 64 for typing in an appropriate code to monitor or deactivate one or more tampering devices.

A wireless device 50 may also be used to deactivate one or more tampering devices used in conjunction or part of the protection device 1. The wireless device may be comprised of a keypad 54 for typing in a code and a transmitter and/or antenna for transmitting a wireless signal to the protection device 1.

FIG. 2 shows a flow chart 200 of a method for detecting and punishing tampering of a water system protection device, such as the device 1 of FIGS. 1A-E. FIG. 3 shows a block diagram of an apparatus 300 which includes anti-tampering components for a water system protection device, such as components that may be used with the water system protection device 1 of FIGS. 1A-E or other water system protection devices, such as fire hydrant protection device, shown in U.S. Pat. No. 6,463,953 which is incorporated herein by reference. The apparatus 300 includes first, second, and third sensing devices 302, 304, and 306, respectively. The apparatus 300 further includes telemetry transmitter 308, alarm 310, processor 312, memory 314, and power sources 316. The apparatus 300 further includes, or may include access port 320, key switch 322, built-in-interface 324, and receiver 326. The devices 302, 304, and 306 are electrically connected to bus 312a of the processor 312 by busses 302a, 304a, and 306a respectively. The telemetry transmitter 308, alarm 310 and the memory 314 are electrically connected to bus 312a of the processor 312 by busses 308a, 310a, and 314a, respectively. The power sources 316 are electrically connected by bus 316b to the devices 302, 304, 306, 308, 310, 312, and 314 by lines 302b, 304b, 306b, 308b, 310b, 312b, and 314b, respectively. The access port 320, key switch 322, built-in-interface 324, and the receiver 326 are electrically connected to the bus 312a of the processor 312 by busses 320a, 322a, 324a, 326a, respectively. The electrical connections may be hardwired, wireless, optical, or any other type of communication connections.

At step 202 of the method of FIG. 2, a water system protection device cover, such as for example, a fire hydrant nozzle cover has been opened or damaged by perpetrators such as unauthorized personnel or vandals. For example, with reference to FIGS. 1A-1E, the cover, i.e. portions 8 and 10 of water system protection device 1, may be opened or damaged by perpetrators. At step 204 this opening or damaging of the cover is detected. Referring to FIG. 3, the opening or damaging of the cover (portions 8 and 10) may be detected by a first sensing device 302, a second sensing device 304, a third sensing device 306, or additional sensing devices. The first sensing device 302 may be comprised, for example, of the tamper switch 22 of FIG. 1A. The second sensing device 304 may be comprised, for example, of the combination tamper switch and telemetry transmitter 24. The third sensing device 306 may be comprised, for example of the breakage detection wire 21. The components of a water system protection device 1 in accordance with the present invention may be comprised of any number of additional sensing devices 28, such as in FIG. 1A, that sense tampering of the water system protection device 1. For example each of the anti-tampering sensing devices may be comprised of conventional electrical contacts, proximity switches, mechanical switches, load cells, pressure switches, tilt switches, vibration sensors, photoelectric sensors, magnetic contacts, hall effect sensors, temperature sensors, mercury switches, metallic or fiber optic continuity loops, and the like.

Devices 302, 304, and 306 send a signal via busses 302a, 304a, and 306a and via bus 312a to processor 312 to indicate that tampering may have occurred. If the processor 312 determines the set of signals constitutes a tampering event, the processor 312, sends a signal to telemetry transmitter 308, via busses 312a and 308a, to cause the telemetry transmitter to receive power from power supply or source 316 and to transmit a signal indicating that tampering of a water system protection device, such as device 1 of FIGS. 1A-1E, has occurred. The telemetry transmitter 308 may send out an encrypted location identification signal, which may identify the location of water system protection device 1. The telemetry transmitter 308 may send out an encrypted status signal, which may contain data such as which of the sensing devices (such as 302, 304, or 306) triggered the alarm 310, the condition of power supply or power source 316, or other information which may be used to determine the nature of response required or indicate the system integrity of the water system protection device, such as device 1 of FIGS. 1A-1E. The processor 312 may also send a signal to alarm 310 to cause activation of the alarm 310. The alarm 310 may be, for example, an audio alarm or a visual alarm.

The devices 302, 304, 306, the telemetry transmitter 308, the alarm 310, the processor 312, the memory 314, may have one or more power sources 316. The power sources 316 may be located inside the water system protection device, such as device 1. The power sources 316 may be self-contained, electrically powered by disposable or rechargeable battery, solar, line voltage, or any other power source.

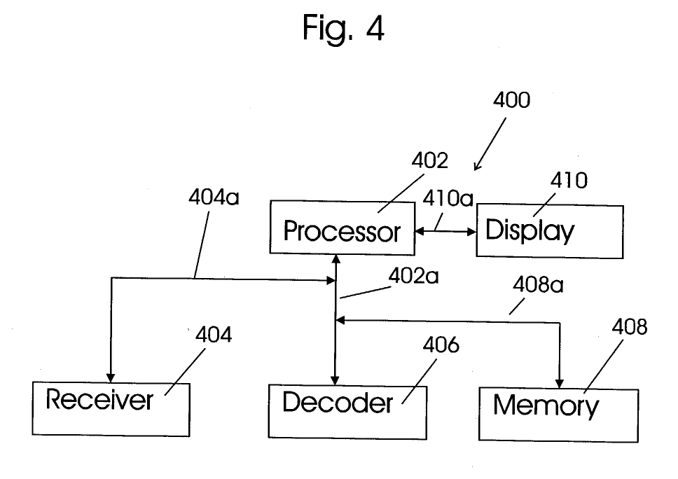

The apparatus or sensing device 300 may indicate that it is operating properly by periodically transmitting a supervisory heartbeat message to a central monitoring facility (such as the facility of apparatus 400 in FIG. 4). For example, processor 312 may retrieve data for a normal operation signal from memory 314. Processor 312 may then cause a normal operation signal to be transmitted via telemetry transmitter 308, every one minute or some other fixed or random interval, or upon request, if the water system or water system protection device 1 has not been tampered with. An additional indication of proper operation of water system protection device 1 may be provided via an audible signal, visual display, or light and/or accessible test points contained on or within the water system protection device 1.

FIG. 4 shows a block diagram of a remote monitoring facility or apparatus 400 for monitoring tampering of a water system protection device, such as device 1 of FIGS. 1A-1E. The apparatus 400 includes a processor 402, a receiver 404, a decoder 406, and a memory 408, and a display or computer monitor 410.

The receiver 404 and the memory 408, are electrically connected to a bus 402a of the processor 402 via communications lines 404a, and 408a. The decoder is electrically connected to the bus 402a.

The receiver 404, at the remote monitoring facility or apparatus 400, receives a signal indicating that the water system protection device 1 has been tampered with. The signal received by receiver 404, may be an encrypted location signal. The receiver 404 may send the encrypted location signal to the processor 402. The processor 402 may decode an encrypted location signal or may send the encrypted location signal to the decoder 406 for decoding. The decoder 406 may provide the processor 402 with an indication of the location of the water system protection device 1 that has been tampered with. The processor 402 may send data indicating the location of the water system protection device 1, to the display 410 for viewing by a human operator or monitor at the remote monitoring facility 400. Apparatus 400, automatically or by a human operator, may then dispatch a response team, such as police, to stop and/or apprehend the individual or individuals who have tampered with the fire hydrant 110 and the water system protection device 1.

The signal received at the receiver 404 may also include further data such as status information relative to the water system protection device 1. The signal transmitted by telemetry transmitter 308 may be a radio frequency signal, a cellular signal, a microwave signal, a signal transmitted to a satellite for transmitting to the monitoring apparatus 400, or any other wireless or wired communication methodology.

Each tampering sensing device, such as apparatus 300, may be assigned a unique identifier code in the form of an electronic serial number. The assignment of a device's electronic serial number may be permanent or non-permanent. This assignment may occur either at the time of manufacture of apparatus 300 such as in an encoded read only memory (ROM), or field-programmable into electrically erasable programmable read only memory (EEPROM) at the time of installation and commissioning.

The presence of a tampering sensing device, such as the components of apparatus 300, within a protective device or as part of a water system protective device, such as device 1, may or may not be visible. Once installed on the object to be monitored (such as a fire hydrant) the exterior housing of the fire hydrant (for example) may reveal the monitoring device or apparatus 300 in plain view, partially concealed, or the apparatus 300 (tampering sensing device) may be completely concealed within the object to be monitored making possible the use of a non-tampering sensing device-equipped decoy fire hydrant or other water system device in the field.

The protective device 1 and the apparatus 300 (tampering sensing device) may be attached to an object, such as a fire hydrant, using any number of methods. It is important to note that the primary purpose of the “lock” on a water system protective device 1 is typically not to delay access to or to make the water system device, such as a fire hydrant, impenetrable, but simply to close and seal the protective device, such as device 1, so that all of the device's interlocks and sensors, such as of apparatus 300, may be activated. The attachment may use an internal or external mechanical or electrical locking mechanism, on the device itself (possibly one containing an electric switch interfaced with the controller); or an external lock, such as a keyed padlock or combination lock, which may secure a hasp, ring, or other locking device, such as shown in FIGS. 1A-1E. Sealing may also be achieved by using a non-removable single use closure such as a plastic or soft metal wire or ring—for example a plastic wire tie, or a wire and lead seal such as is used on utility meters—or other objects which are by design intended to be removed only by cutting or breaking. There are numerous such sealing devices available on the market.

Upon the installation and commissioning of a water system protective device containing a tampering sensing device, such as apparatus 300, the geographical location of the installed site (such as the location of a fire hydrant) is determined and registered with the central monitoring facility or apparatus 400 where it is stored in a secure database, such as memory 408. In addition to the central monitoring facility or apparatus 400, access to the database or memory 408, may also be provided to authorized persons in fire or law enforcement agencies. A self-test procedure may be employed to verify proper functioning of the unit or apparatus 300. This may include self-diagnostics, status indicator displays on the unit or apparatus 300, externally accessible test points, and/or transmission tests.

An embodiment of the device, such as apparatus 300, may have the ability to store its location coordinates, such as in memory 314 of FIG. 3, obtained from Global Positioning Satellite (GPS) data. This capability may be in place of or in addition to manual entry of the tampering sensing device's (apparatus 300's) installation coordinates into a location database, such as memory 408 of monitoring facility or apparatus 400. A standard portable GPS receiver and or a specialized GPS Receiver and processor with interface capabilities may be provided to personnel for use in commissioning each unit (such as apparatus 300). The device 50 shown in FIG. 1, may include a GPS receiver. Alternatively, the GPS receiving and processing capability may be incorporated into the tampering sensing device unit (such as apparatus 300) itself. In this case, a GPS processor would be part of or coupled to the internal processor, such as processor 312 of the apparatus 300 and the GPS processor may determine the location of apparatus 300 using signals received from GPS satellites, such as from receiver 326, with the telemetry transmitter 308 sending a signal carrying the stored position information to a central monitoring facility, such as the apparatus 400, along with data indicating which monitoring device, i.e. which apparatus 300, at which location, has been tripped.

Apparatus 300 may be equipped with one or more interfaces such as access port 320, key switch 322, built-in interface 324, and detachable interface 60 and/or receiver 326 shown by FIGS. 1A and 3, which will permit, authorized persons to communicate with apparatus 300 in the field. The communication function may be used to initiate report transmissions, trigger testing modes, change parameters, update software, perform maintenance, to activate or deactivate functions of the tampering sensing device (apparatus 300), or the like.

The water system protective device 1 with the addition of or including a tampering sensing device, such as apparatus 300, will typically incorporate a number of tamper detection sensors. For security reasons, the number, type, and precise placement of sensors employed in any given embodiment of the apparatus, such as apparatus 300, may not be disclosed to the public. However, the tampering sensing device, such as apparatus 300, will typically contain at minimum one or more internal or external contact switches, which upon removal of the protection device 1, either open or close an electrical circuit interfaced with the processor 312 of the apparatus 300. In addition, the water system protective device 1 may be equipped with temperature, vibration, acoustic or other sensors or sensing devices to detect if excessive heat, cold, shock, or other forces are being applied in attempt to disable the water system protection device 1 or apparatus 300. The protective device 1 may have on or below its interior or exterior surfaces a number of conductive paths. These devices would be broken if the water system protection device 1 or 300 was cracked, cut, or otherwise physically damaged. All of the above-sensors can be interfaced to the processor 312, at for example, a fire hydrant, or to the monitoring facility 400.

Upon the triggering of one or more of sensing devices or sensors of the apparatus 300, caused by the occurrence of a tampering or other event, the processor (controller) 312 processes signals from the sensing devices (such as 302, 304, and 306) and, depending on the tamper reporting mode, activates the telemetry transmitter (such as transmitter 308), sending a tamper report to the central monitoring facility 400. The telemetry is routed to the central monitoring facility 400, which takes an appropriate action, such as informing the police or other law enforcement of the location and conditions surrounding a suspected tampering event.

The apparatus 300 may be configurable in a number of tamper reporting modes. In one mode a tamper report signal would be transmitted, such as via telemetry transmitter 308 upon activation of any sensors contained within the apparatus 300 (tamper sensing device) whether by tampering or by authorized user utilizing a key to open the protective device, such as protective device 1. Another mode would permit the disabling of the transmission function for legitimate purposes, such as maintenance or testing. In this mode the apparatus 300, will not transmit a tamper report, via telemetry transmitter 308 upon normal opening by key switch, such as key switch 322, but only when the controller or processor 312 had determined the protective device 1 was tampered with.

Other reporting modes may be devised which would report only upon certain sensor or operating conditions, on a predefined schedule, on a random schedule, or upon request based on the reception of a signal from an external source, such as a transponder “squawk” code signal.

The telemetry transmitter, such as telemetry transmitter 308, may be comprised of a cellular telemetry transmitter. The telemetry transmitter, such as telemetry transmitter 308, may be comprised of a satellite telemetry transmitter, a cellular telephone, a radio transmitter, landlines or any combination thereof in a redundant configuration. In areas where cellular service is unavailable, the telemetry transmitter, such as telemetry transmitter 308, may communicate via radio to a local telemetry receiver, which in turn may provide a connection to the central monitoring facility, such as apparatus 400, by hardwired, radio, cellular, satellite, Internet, or other communication method.

Once any of the systems sensors or sensing devices (such as 302, 304, or 306) of the apparatus 300, have been triggered, the processor 312 will decide whether the current set of sensor conditions is to be interpreted as a tampering event. If the set of sensor conditions is determined to be a tampering event the processor 312 sends a tamper report to the monitoring facility or apparatus 400. The tamper report signal will typically include at a minimum a location identifier, the device electronic serial number or some other identifying code of the apparatus 300. The signal may also contain the protective device's, such as device 1's, geographical location in an either encoded or human readable form. If the protective device 1 and the additional or included apparatus 300, has internal GPS capability, the internal processor 312 determines the location of the apparatus 300 using signals received from the GPS (Global Positioning) satellites and the telemetry transmitter, such as telemetry transmitter 308, sends a signal carrying the stored position information. The signal may also contain additional data such as the conditions of each sensor or sensing device, such as sensing devices 302, 304, and 306 in the apparatus 300, at the time of the alarm. The totality of the sensor or sensing device data may be used to validate or activate the alarm, such as alarm 310, ascertain its cause, and to determine the nature of response required. For example, a low battery sensor activation may cause a fire official to be dispatched, while the activation of the device's (apparatus 300) vibration sensor followed shortly by a break in the outer casing's continuity sensors may be interpreted as an aggressive attempt to compromise the integrity of the protective device 1 and/or the apparatus 300 and warrant deployment of a special response unit.

The protection device 1 and the apparatus 300, once commissioned may be permanently armed, or may be capable of being field-deactivated by authorized persons (fire, law enforcement, utility departments, etc.) for legitimate purposes. The means of deactivation may be by key operated switch, such as switch 322 in FIG. 3, or other input device such as a keypad in that would be incorporated in the protective device 1 and/or the apparatus 300, for example as built in interface 324 or through access port 320, and accessible in the field. Deactivation may also be accomplished by connecting a separate detachable wired or proximity device, such as device 60 in FIG. 1A, or by use of a suitable wireless transmitter such as device 50 in FIG. 1A. The operation of any of the above deactivation devices may require the entering of a specific code sequence into a keypad (such as one of keypads 54 or 64) such as a personal identification number (PIN) which may either be validated by the device (such as devices 50 or 60, respectively), or transmitted to the central monitoring facility, such as apparatus 400, for validation along with an alarm signal, such as by alarm 310. Or the wireless deactivation device 50 used by authorized field personnel could transmit a deactivation signal to the central monitoring facility, such as apparatus 400, through the apparatus 300 (tampering sensing device) and then would be confirmed by the central monitoring facility 400. Once the central monitoring facility 400 determines the attempt at deactivation is by an authorized field technician the central monitoring facility 400 may download a temporary deactivation code to the tampering sensing device or apparatus 300. This code may deactivate the tampering sensing device or apparatus 300 for a specific period of time, re-enabling of the tampering sensing device or apparatus 300 automatically may occur or manually after the set period of time, and/or the deactivation procedure may require voice contact/confirmation between the field representative and central station personnel to complete the deactivation sequence. Supplying an incorrect personal identification number (PIN) or other identifier along with the deactivation request may result in the transmission of a tamper report.

The controller or processor 312 may perform a power management function. Of the functions performed by the tampering sensing device or apparatus 300, signal transmission is a much heavier consumer of power than the monitoring and processing function. In order to conserve power, the apparatus 300 may include more than one internal power source. The apparatus 300 may include a processor 312 configured to switch on and off the second switchable power source. A first power source may be coupled to the processor, while a second switchable power signal is intermittently coupled to the telemetry transmitter, such as telemetry transmitter 308. Power may be applied to the telemetry transmitter, such as telemetry transmitter 308 in brief pulses, or withheld from the telemetry transmitter 308 until the processor 312 determines a tampering event is occurring. The tampering sensing device, such as apparatus 300, may include self-diagnostics and would alert the central station, such as central monitoring facility 400, of a low battery condition or other systems problems, which may cause the central station monitoring facility 400, to dispatch a service technician to the location for repair or replacement of the apparatus 300.

Each power source, such as power source 316 (which may be comprised of a plurality of power sources) and any further number of power sources, may be of a different type and have different performance and lifetime characteristics. For example, a power source for the processor 312 may provide long life under low drain conditions, whereas another power source may be provided for the telemetry transmitter 308 that may provide long storage capability and may provide high power for short periods of time. The conditions of each power source of power source 316 may be automatically monitored by the controller or processor 312 and may be viewable via a display, test point, or reported to a monitoring facility, such as facility 400.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

We claim:

1. An apparatus comprising
a transmitter; and
a water system protection device that inhibits an unauthorized individual from accessing water from a water system device; and
wherein when the water system device is tampered with the transmitter transmits a first signal.

2. The apparatus of claim 1 further comprising
a device which allows an authorized individual to access the water system protection device without causing the transmitter to transmit the first signal.

3. The apparatus of claim 2 wherein
the device which allows the authorized individual to access the water system protection device is comprised of key operated switch.

4. The apparatus of claim 2 wherein
the device which allows the authorized individual to access the water system protection device is comprised of a keypad.

5. The apparatus of claim 2 wherein
the device which allows the authorized individual to access the water system protection device is comprised of a wireless device.

6. The apparatus of claim 1 further comprising
a global positioning satellite receiver which can receive global positioning satellite signals;
and a processor which used the global positioning satellite signals to determine the position of the water system protection device.

7. The apparatus of claim 1 wherein
the transmitter is located within the water system protection device so that the transmitter cannot be accessed by an unauthorized person without tampering with the water system protection device.

8. The apparatus of claim 1 wherein
the water system device is a fire hydrant; and
the water system protection device is a fire hydrant protection device.

9. The apparatus of claim 1 further comprising
a first sensing device that senses when the water system protection device has been tampered with, and causes the transmitter to transmit the first signal.

10. The apparatus of claim 9 further comprising
a second sensing device that senses when the water system protection device has been tampered with, and causes the transmitter to transmit a second signal.

11. The apparatus of claim 1 wherein
the transmitter transmits a normal operation signal indicating that the water system protection device has not been tampered with.

12. The apparatus of claim 1 wherein
the first signal is encrypted.

13. The apparatus of claim 1 wherein
the first signal indicates the location of the water system device.

14. The apparatus of claim 1 further comprising
an alarm located at or near the water system device, wherein the alarm is activated when the water system device is tampered with.

15. A method comprising
transmitting a first signal from a location at or near a water system device when a water system protection device has been tampered with;
wherein the water system protection device inhibits an unauthorized individual from accessing water from the water system device.

16. The method of claim 15 wherein
the water system device is a fire hydrant; and
the water system protection device is a fire hydrant protection device.

17. The method of claim 15 wherein
the first signal is encrypted.

18. The method of claim 15 further comprising
transmitting a normal operation signal indicating that the fire hydrant protection device has not been tampered with.

19. The method of claim 15 wherein
the first signal indicates the location of the water system device.

20. The method of claim 15 further comprising
activating an alarm located at or near the water system device when the water system protection device is tampered with.

21. The method of claim 15 further comprising
receiving the first signal at a monitoring facility;
and causing one or more members of a law enforcement agency to be sent to the location at or near the water system device.

22. The method of claim 21 wherein
the first signal is encrypted;
and further comprising decoding the first signal at the monitoring facility to determine the location at or near the water system device.

23. The method of claim 15 further comprising
allowing an authorized individual to access the water system protection device without causing the first signal to be transmitted.

24. The method of claim 23 wherein
the authorized individual is allowed to access the water system protection device by use of a key operated switch.

25. The method of claim 23 wherein
the authorized individual is allowed to access the water system protection device upon entry of a code into a keypad.

26. The method of claim 23 wherein
the authorized individual is allowed access to the water system protection device by used of a wireless device.

27. The method of claim 15 further comprising
receive global positioning satellite signals; and
determine the position of the water system protection device based on the global positioning satellite signals.
